(19) United States
(12) Patent Application Publication
(10) Pub. No.: US 2012/0086807 A1
(43) Pub. Date: Apr. 12, 2012

(54) METHOD AND DEVICE FOR THE VISUAL DISPLAY OF SURROUNDINGS OF A VEHICLE

(76) Inventor: Stephan Simon, Sibbesse (DE)

(21) Appl. No.: 13/252,757

(22) Filed: Oct. 4, 2011

(30) Foreign Application Priority Data
Oct. 11, 2010 (DE) 102010042248.7

(51) Int. Cl. H04N 7/18

(52) U.S. Cl. 348/148; 348/E07.085

(57) ABSTRACT

A method for visually displaying surroundings of a vehicle, includes recording a surrounding image field with a wide-angle lens, rectifying the surrounding image field recorded with the wide-angle lens by producing a display image field, which reproduces the surrounding image field in rectified form, and displaying the display image field. The rectification includes imaging the surrounding image field according to a rectification acting at least in the vertical direction, which shows a lower edge of the recorded surrounding image field on a lower setpoint image edge. The setpoint image edge at least approximately corresponds to an outer contour section of the vehicle. The course of the setpoint image edge differs from the lower edge. The rectification represents continuous imaging for pixels of the surrounding image field which are not on the lower edge. A related device for the visual display of surroundings of a vehicle is also described.

### CROSS-REFERENCE

The present application claims the benefit under 35 U.S.C. §119 of German Patent Application No. DE 102010042248.7 filed on Oct. 11, 2010, which is expressly incorporated herein by reference in its entirety.

### BACKGROUND INFORMATION

Conventional camera systems or other optical systems can convey image information about the vehicle surroundings to the driver, which goes beyond the field of vision through the vehicle windows, in order to make the driver capable of being able to better judge unclear traffic situations (in particular close to the vehicle and at locations remote from the driver). For this purpose, simple optical measures are used, such as Fresnel lenses, which are located on rear windows of motor homes, for example, but increasingly also electronics-supported apparatuses, in which a camera (in particular a rear camera) on the vehicle rear records the surroundings in order to display it in the field of vision of the driver (at the cockpit) using a display.

One goal of this camera is to reproduce the surroundings as completely as possible, i.e., having the widest possible range of vision. The wider the range of vision, however, automatically the greater the distortion, which may be considered to be an image of a hemisphere on a plane in the case of wide-angle lenses as a simplification.

Due to the distortion, the observation of the camera image on a typical (flat) display results in misinterpretations with respect to position and movement direction of imaged objects. Up to this point, the distortion has only been able to be reduced in that the image field is restricted; however, this is also undesirable, since in this way misinterpretations also arise (due to blind spots), or the recording is incomplete.

It is an object of the present invention to allow a visual display, using which the surroundings may be recorded more correctly.

### SUMMARY

The present invention may allow a greatly improved visual display of a recorded surrounding area, which correctly conveys the essential features for the observer. In particular, objects which are immediately close to the vehicle, but are at different distances from the center of the image field, are not shown at different distances from the lower image edge. In spite of the wide image field (for example, at least 180° or 190°), objects at the image edge are not incorrectly shown at a greater distance to the lower image edge than objects in the image center at the same distance. In particular in the case of rear cameras, this allows a better assessment of the distance of crossing pedestrians and/or objects at parking spaces during parking maneuvers, for example. Movement directions are correctly shown by the rear camera in the same way. While without the measure according to the present invention, objects having a traversing relative movement through the image field due to the distortion by the wide-angle lens have been shown with a movement which displays the object toward the image edge with increasing distance from the vehicle, i.e., a display of the movement away from the vehicle the closer the object comes to the image edge, in the display according to the present invention, the movement direction is not reproduced incorrectly. The present invention may be implemented by simple measures and may be readily integrated into existing systems.

By wide-angle displays, a position on the image edge may be shifted all the more upward due to the circular curvature of the image (in particular at the upper/lower image edge) the more the position is located on the side edge of the image field, and this may result in hazardous misinterpretations of a traffic situation. In the same way, the circular curvature of the image distorts the movement direction away from the vehicle if an object moves toward the lateral image edge, this also possibly resulting in hazardous misinterpretations. The present invention allows an intuitively correct interpretation of the situation, and in particular the reliable and correct recording of nearby objects on the lateral image edge.

Furthermore, a correct display of the course of the lower image edge is made possible, whereby the observer may readily correctly capture the situation, in particular without having to consider the special features of the distortion by the wide-angle lens.

An example embodiment of the present invention provides the display of the surrounding image field in rectified form, the lower image edge, which displays an area closest to the vehicle, not being provided with the curvature which is produced by the wide-angle lens, but rather being adapted in its course to the course of the vehicle at this position. Due to the adaptation of the display to the actual shape (i.e., the course) of the outer vehicle section, nearby objects may be recorded unaltered with respect to distance and relevance for the vehicle. The wide-angle recording allows a display of a wide image field in spite of the rectification on the lower image edge. An example embodiment of the present invention provides for adapting the lower edge of a surrounding image field with respect to its course to a lower setpoint image edge, and for rectifying the pixels or the image information above the lower edge (i.e., pixels which are not on the lower edge) according to this adaptation. The entire surrounding image field is thus adapted to the shape of the setpoint image edge. In particular, no artificial jump results within the rectified image, since the rectification of the lower edge and the rectification of the further area (above the lower edge) merge into one another continuously according to a continuous image. The rectification which originates from the lower edge therefore extends over the entire surrounding image field and displays the surroundings in an easily comprehensible, intuitive way.

In accordance with the present invention, an example method is provided for the visual display of surroundings of a vehicle. This method provides that a surrounding image field is recorded with the aid of a wide-angle lens. The surrounding image field recorded with the aid of the wide-angle lens is rectified by producing a display image field, which reproduces the surrounding image field in rectified form. The production provides that the surrounding image field is mapped. In addition, the display image field is displayed. The rectification is provided in that the surrounding image field is imaged according to a rectification. It is therefore provided that the surrounding image field is imaged according to a rectification acting at least in the vertical direction. This rectification shows a lower edge of the recorded surrounding image field on a lower setpoint image edge. The setpoint image edge at least approximately corresponds to an outer contour section of the vehicle or a predefined course (in particular a horizontal course, for example, a straight line). The course of the setpoint image edge differs from that of the lower edge. The rectification (i.e., the image according to the present invention) is a unique (in particular continuous or sectionally continuous) image for at least a subgroup of pixels of the surrounding image field (or for all pixels of the surrounding image field), which are not on the lower edge, in particular this image and the image (i.e., rectification) of the lower edge being assigned to a common, unique. (preferably continuous) image. The unique image may in particular be an injective image, or in particular on or at the setpoint image edge a surjective image, or a bijective image. The image shows adjacent pixels of the surrounding image field on adjacent pixels of the display image field, the relative orientation of adjacent pixels preferably also being maintained.

In the context of the present invention, an image is continuous if two adjacent points are in turn shown as adjacent points and the distance between two slightly spaced-apart points (for example, two adjacent pixels) is shown by the image in points which are also only slightly spaced apart. In other words, a jump is preferably not provided by the image. In this regard, discretizations, such as occur when an electronic camera is used (pixels), are not referred to as a jump, since the observer does not detect an actual jump as a result of the high resolution and therefore a continuous image/display of the surroundings is detected. Rather, a jump in the meaning of a discontinuity is referred to as a visible, substantial offset of image sections, which goes beyond the rasterized discretization by the image pixels. The image of the lower edge of the recorded surrounding image field on the setpoint image edge is in the foreground, so that images of the remaining surrounding image field, which are sectionally continuous, are also encompassed by the method according to the present invention. The surrounding image field is shown faithfully to the object, i.e., it is shown in such a way that an observer readily recognizes the object in spite of the image, i.e., characteristic shapes are fundamentally maintained. This allows the recognition of the objects in spite of the image (deformation by rectification). This is possible in particular through the use of a holomorphic image as the rectification.

In accordance with the present invention, an example method is provided in which the rectification only runs in the vertical direction (in general: in only one direction) and the strength of the rectification in the vertical direction corresponds to the vertical difference between the setpoint image edge and the lower edge. The rectification is therefore a displacement of the pixels in this direction, i.e., the displacement direction of the rectification is the vertical. The strength of the rectification, i.e., the distance of the displacement, is a function of the horizontal position, is variable along the horizontal, and in particular corresponds to the distance between the setpoint image edge and the lower edge, which is used as the correction factor.

According to one aspect of the present invention, the method is executed using an electronic arrangement, the image being electronically recorded (with the aid of a wide-angle camera) and electronically rectified. The step of recording the surrounding image field is provided by recording the surrounding image field with the aid of an electronic camera through the wide-angle lens. The camera converts the surrounding image field into camera image data; for example, the camera is designed as a CMOS camera or CCD camera, or the like.

The step of imaging is provided by an electronic image processing device, which rectifies the camera image data according to the rectification. The image processing device may be a programmable data processing system, for example, a processor, on which software runs, which implements at least some of the method steps. The image processing device includes a rectification function dependent on a horizontal position specification or receives it from another component of the system. The rectification function is dependent on the horizontal position specification, in that the strength of the rectification, which is dependent on the rectification function, changes with the horizontal position specification. The rectification is in particular an offset or a displacement for this purpose, preferably in the vertical direction (i.e., perpendicular to the horizontal direction of the horizontal position specification).

The rectification function reproduces the vertical distance between the lower edge of the surrounding image field and the lower setpoint image edge, dependent on the horizontal position specification. The rectification function therefore maps pixels onto pixels vertically offset thereto, the width of the offset (or the displacement) being dependent on the horizontal position. The image processing device is therefore based in this case on an imaging function which offsets the pixels relative to one another.

One alternative specific embodiment provides that the image processing device provides the rectification with the aid of actual and setpoint functions. The difference between the actual and setpoint functions corresponds to the relative offset as described above. The actual and setpoint functions correspond to absolute specifications of courses which relate to the surrounding image field, and whose ratio to one another corresponds to the above-described rectification function, which relates to the distance. The two alternative display modes (absolute and relative) are exchangeable.

A form of display based on absolute specifications provides that the image processing device includes or receives (for example, from another component of the device) an actual function dependent on a horizontal position specification and a setpoint function dependent on a horizontal position specification.

The actual function reproduces the vertical height of the lower edge of the surrounding image field as a function of the horizontal position specification. The setpoint function reproduces the vertical height of the setpoint image edge as a function of the horizontal position specification. The rectification may thus be adapted to the real conditions (optical system of the camera, vehicle exterior or setpoint image edge adapted to the real course of the object, which defines the setpoint image edge) by adaptation of the functions.

Imaging is executed by vertical offset of the camera image data according to the rectification function (in particular in the relative display modes) or according to the difference between the actual function and the setpoint function (in particular in the absolute display mode).

According to another specific embodiment, the rectification provides that all pixels of the surrounding image field which are in the same vertical are vertically displaced by the same amount (i.e., by the same distance). The rectification is provided particularly simply in this case by a displacement/offset along the vertical, the displacement only being dependent on the horizontal position and the same offset amount being used for each individual horizontal position.

The present invention is preferably performed using discrete pixels which electronically reproduce the camera image. Since the offset may differ in particular for adjacent columns (=pixel series in the vertical direction) (since the offset is dependent on the horizontal position), annoying image errors may result due to the differing displacement of the columns. These are reduced or removed by interpolation. Therefore, the method preferably provides that the surrounding image field which is shown according to the rectification is interpolated. Furthermore, the image field data may be interpolated during the imaging, i.e., during the step of the offset or displacement of the pixels according to the rectification. The interpolation includes in particular the balancing of color or grayscale values of pixels, which come to rest adjacent to one another or close to one another due to the rectification. The interpolation therefore includes the interpolation of color or grayscale values which reproduce the surrounding image field. The interpolation is executed according to a linear or bilinear interpolation, according to a higher-order interpolation, according to a cubic or bicubic interpolation, or according to another interpolation method. The interpolation is executed in particular according to an interpolation which runs in the vertical direction, the interpolation further being able to run in the direction horizontal thereto. The preceding interpolation methods and features may be combined with one another.

Furthermore, it is provided that the lower edge of the recorded surrounding image field has a curved course. This is provided with the aid of a polynomial function, a polynomial function symmetrical to the vertical, a polynomial function having a minimum in the center or having a minimum between the lateral edges of the surrounding image field, with the aid of a circular arc function, or with the aid of another function, which at least approximately reproduces the curvature of the image edge occurring due to the wide-angle lens. The lower edge is approximated in particular by a convex function, which is symmetrical to the central vertical. The course of the lower edge corresponds to a straight line which was recorded and distorted by the wide-angle lens on an image edge of the lens. The rectification according to the present invention is complementary to the distortion of a straight line on the edge (on the lower edge) of the image field of the wide-angle lens.

The course of the outer contour section corresponds to the real course of a contour of the vehicle, in particular a side (e.g., the rear side) of the vehicle, a bumper (or a bumper edge) of the vehicle, or a trunk lid (or a trunk lid edge) of the vehicle. The outer contour section, i.e., the setpoint image edge, corresponds in particular to a course of a rear section of the vehicle. The setpoint image edge is the edge which is recorded by the wide-angle lens on the (lower) image edge of the range of vision of the wide-angle lens. Therefore, the positioning and orientation of the wide-angle lens relative to the vehicle (to the vehicle exterior) are relevant for the course of the outer contour section. Alternatively, the course of the outer contour section corresponds to a predefined symbolic course or a freely selectable predefined course, for example, of a predefined (horizontal) straight line or another predefined horizontal course. The course may be predefined in particular by a desirable, predefined human-machine interface for visualizing the camera data and may be oriented to the image distribution of the visual display (by a visual display which is attached on the cockpit of the vehicle, for example).

Furthermore, it is provided that the display image field is displayed using a visual display, which has generally no distortion, for example, with the aid of a planar display in which the pixels are displayed equidistantly. The visual display is situated in a passenger compartment of the vehicle and faces toward a driver position. The display image field is therefore displayed to the driver within the typical field of vision, in particular in the cockpit of the vehicle. The visual display is in particular an LCD or TFT display screen. The visual display may be designed as a heads-up display or as a display which projects the image to be viewed from the driver position onto a window pane (rear window, side window, or windshield) or onto a mirror (side mirror). The visual display may also display further image information, either simultaneously with the display of the image data recorded, for example, the speed may be displayed simultaneously in the display or the display may also be used for other display purposes (before or after the display of the image data recorded according to the present invention), for example, as a system display or as a display of a navigation system. The display may be provided on the cockpit, may be situated in the direction of one of the outer mirrors, from the driver's viewpoint, or may be provided on the rear window of the vehicle, oriented toward the driver. In the two last mentioned variants, the display is through the rear mirror or through the rear window and the display is in the same field of vision of the driver, whereby the driver may view both displays simultaneously (real through rear mirror/rear window and virtual through the camera data). These display variants may also be integrated by a projection of the display according to the present invention on the windshield, on the rear window, or in one or both of the outer mirrors.

One specific embodiment provides that the display image field is larger than the rectified surrounding image field. Graphic, symbolic, numeric, or alphanumeric vehicle information is reproduced in the area of the display field thus remaining. The vehicle information reproduces driving parameters such as speed, a distance between the vehicle and an object (an adjacent vehicle, or the like) in the surroundings, a movement direction of the vehicle, a steering direction of the vehicle, or a symbolic representation of a recorded traffic situation of the vehicle (for example, a parking scenario).

The method according to the present invention is preferably implemented using an electronic arrangement, in particular the rectification. However, an approach based on an optical arrangement may also be provided, the rectification (partially) being provided by a trapezoidal rectifier optical system, which may be fastened on the wide-angle lens. The trapezoidal rectifier optical system may include a keystone corrector lens or a shift lens. This optical system may provide a part of the rectification according to the present invention, while electronic image processing implements the remaining rectification, in particular the adaptation to the setpoint contour course. The rectification may only be provided by a corresponding corrector lens as a function of the possible optical rectification, the course of the lower edge of the recorded surrounding image field, and the course of the lower setpoint image edge.

An example device according to the present invention is provided by a device for the visual display of surroundings of a vehicle, the device having a camera. The camera is equipped with a wide-angle lens. Furthermore, the device includes a graphic data interface for outputting display image data, which reproduce a display image field, and an imaging device, which is connected to the camera for receiving surrounding image data, which reproduce the surrounding image field. The imaging device is designed to display the image data of the surrounding image field according to a rectification acting at least in the vertical direction. The rectification of the imaging device is provided to show a lower edge of the recorded surrounding image field on a lower setpoint image edge. The setpoint image edge at least approximately corresponds to an outer contour section of the vehicle or another predefined (preferably horizontal) course. The course of the setpoint image edge differs from the lower edge. The imaging device is designed to provide the rectification of the imaging device as a continuous image, in particular for pixels of the surrounding image field which are not on the lower edge. Such a design may be achieved in particular by an electronic imaging device, which implements the rectification as software, which runs on a programmable image data processing unit (e.g., a graphic processor), hardwired circuit parts of the image data processing unit providing a part of the properties, for example, the displacement in the scope of the distortion.

One preferred specific embodiment of the device provides that an interpolation device is also provided, which forms a part of the imaging device. Alternatively, the interpolation device is connected downstream from the imaging device. The interpolation device interpolates the rectified image, which may have various displacements for adjacent rows. The interpolation device is configured to interpolate color or grayscale values which reproduce the surrounding image field, in particular of adjacent pixels, in order to adapt them to one another. The interpolation device is configured to smooth the transition between various displacements in the vertical direction, which are provided by the imaging device, through the interpolation.

The device may also include an image combiner, which positions the rectified image data with image data to be faded in adjacent to one another and combines them, to provide them jointly in one image signal. In addition to the rectified image, further image information may be displayed on the display. The device has another input for the image data to be faded in.

### BRIEF DESCRIPTION OF THE DRAWINGS

Specific embodiments of the present invention are explained in greater detail below on the basis of the figures.

FIG. 1 shows an example device according to the present invention.

FIGS. 2a through 3b show views for more detailed explanation of the mode of operation of the present invention.

### DETAILED DESCRIPTION OF EXAMPLE EMBODIMENTS

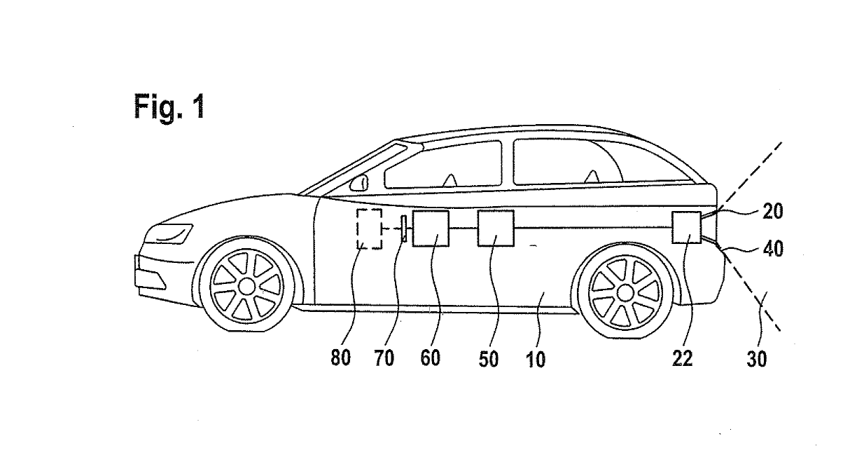

FIG. 1 shows a sectional view of an example device according to the present invention and its positioning in a vehicle 10. A wide-angle lens 20 and an electronic camera 22 are situated on the vehicle. Wide-angle lens 20 records surroundings 30 and a lower edge 40 of detected surroundings 30 is defined by a bumper, above which wide-angle lens 20 is situated.

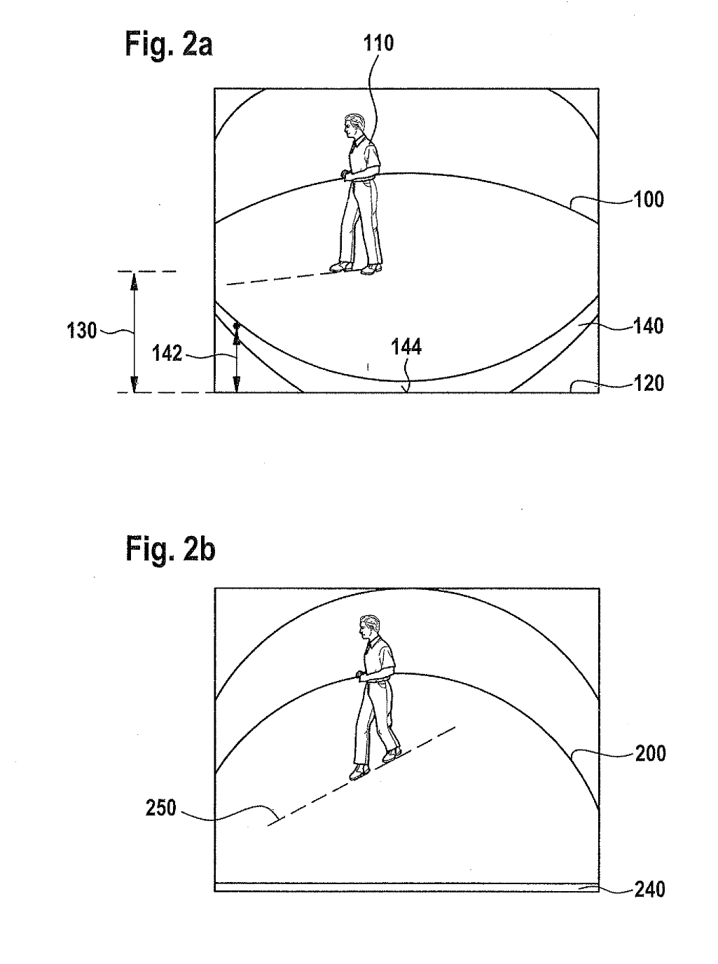

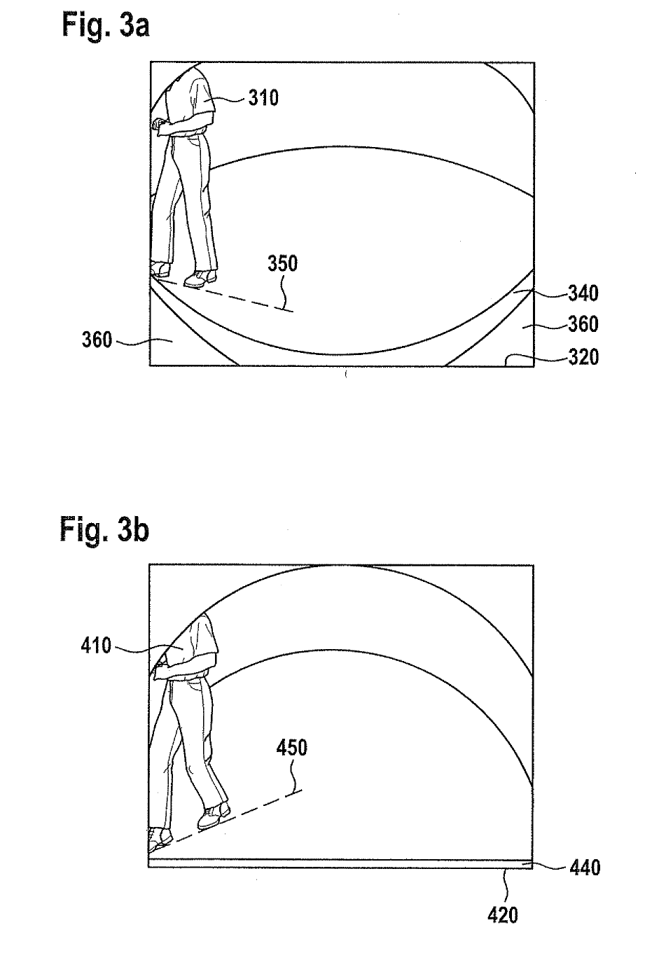

Camera 22 outputs image signals via a line and transmits them to an imaging device 50, which performs the rectification according to the course of lower edge 40 (perpendicular to the image plane) and the course of the setpoint image edge. An interpolation device 60, which outputs the image data to a graphic data interface 70, is connected downstream from imaging device 50. A display 80 (shown by dashed lines), which is situated in the cockpit, for example, may be connected to graphic data interface 70. It is apparent that wide-angle lens 20 has a wide aperture angle, which may be up to 180° or 190° or more. The wide-angle lens shown is inclined slightly downward in its orientation, in general the wide-angle lens also being able to be oriented toward the horizon or upward (and/or also laterally). Distortions, which are shown in greater detail on the basis of FIGS. 2a through 3b, result due to the aperture angle.

FIG. 2a shows a surrounding image field as it is detected by the wide-angle lens. A horizon 100 is shown, which is already distorted in a curve due to the slightly downward inclined orientation of the wide-angle lens. A person 110 traverses behind the vehicle in the field of vision of the camera; the movement direction is shown by a dashed line. A lower, curved image edge, i.e., the lower edge of the recorded surrounding image field, is formed by the bumper of the vehicle. Lower edge 140 is strongly distorted, i.e., shown strongly curved, although the bumper has a generally linear course. Lower edge 140 is a strip in FIG. 2a, but may also be a line. Since the distance is intuitively estimated by height 130 of the object (i.e., the distance between the lowermost point of object 110 and the image edge) in relation to lower image edge 120 shown and, furthermore, lower image edge 140 is curved strongly upward at the ends, the actual distance may only be detected with difficulty, in particular if the person is located closer to the image lateral edge.

FIG. 2b shows a display rectified according to the present invention. The lower edge of the recorded surrounding image field is imaged on a generally linear setpoint image edge 240. Since this corresponds to the real shape, the distance may be detected more intuitively. Furthermore, movement direction 250 is shown having a stronger angle toward the vehicle, so that this critical situation may be better detected and is shown more pronounced than in the case of unrectified FIG. 2a. Through the rectification, above all the near range on the vehicle rear side is shown in such a way that the driver may capture the situation well. The stronger curvature of horizon 200 is not detrimental thereto, but rather is used to display the surrounding image field in its entire width. Furthermore, it is apparent that the upper image edge was also displaced toward setpoint image edge 240. The generally vertical displacement increases in its strength with decreasing distance from the lateral edge of the display image field.

The course of lower edge 140 is strongly curved, lower edge 140 being mapped on (lower) setpoint image edge 240, which has a linear course, see below. The rectification linked thereto may be detected in greater detail by the observation of the distances of lower edge 140 from a horizontal line (example here: the image lower edge of display 120): At a horizontal position on the edge, a greater distance 142 results than at a central position 144 of the image lower edge of display 120 (no distance). Since the setpoint image edge also runs linearly, a rectification is provided by a vertical displacement downward having a displacement distance which is a function of a horizontal position. At the edge, the displacement distance is distance 142, in the (horizontal) center, this is zero, and in between it is the same size as the vertical distance of lower edge 140 from the target course (horizontal straight line, for example, image lower edge 120). An image results in which the lower edge corresponds due to the displacement to the target course (i.e., a straight line; here: image lower edge 240), see FIG. 2b. The resulting effects for the display are explained hereafter.

In FIGS. 2a and b in particular, a person is shown in the image center, whose movement direction is inclined more strongly toward the vehicle due to the rectification. In order to show the influence of the distortion at the image edge, a scenario is shown in FIGS. 3a and 3b in which a person is located at the edge of the surrounding image field.

A wide-angle recording which is not rectified according to the present invention is shown in FIG. 3a. A person 310 is located at the image edge and, due to the inclination of lower edge 340, which is oriented strongly upward, the person is shown at a large distance from the lower image edge, although the person is located very close to the bumper, which forms lower edge 340. A correct orientation by an observer is therefore difficult. Furthermore, movement direction 350 is to be noted, which is inclined away from lower edge 320 of the display image field due to the distortion of lower image edge 340, although the person is actually moving slightly toward the vehicle. An observer also receives a false impression of the real situation here.

The image shown in FIG. 3a is reproduced in rectified form in FIG. 3b, i.e., having a linear setpoint image edge 440 (in the form of a strip), which runs parallel to lower edge 420 of the display image field (in the form of a straight line section). In particular, lower edge 420 of the display image forms the lower boundary line of setpoint image edge 440. Furthermore, it is apparent from the comparison of FIGS. 3a and 3b that lower image corners 360, which are rather interfering for detecting the situation, are no longer imaged due to the rectification (i.e., displacement) (since they are below setpoint image edge 420). Furthermore, it is noticeable from the comparison that person 310 is shown in FIG. 3a having a significant distance to lower image edge 320, although the actual distance is small, the distance being shown more correctly in FIG. 3b and person 410 being shown very close to lower image edge 420. The distance is thus assessed more correctly.

In addition, it may be detected directly that movement direction 350 of person 310 incorrectly points away from the vehicle in FIG. 3a, although the movement direction actually runs toward the vehicle. The movement direction is shown more correctly in FIG. 3b, since in particular the relevant lower image section (corresponding to the near surroundings of the vehicle) is displayed more conformal and movement direction 450 is correctly oriented toward the vehicle in FIG. 3b. The setpoint image edge reproduces the actual course of the vehicle component, which delimits the actually recordable lower image field. Therefore, all objects which are shown close to the lower setpoint image edge are reproduced having correct angular distortion and a distance to the lower image edge, so that in particular the area close to the vehicle is reproduced having a correct distance and a correct angle. In contrast, the upper area relates to objects which are farther away, and are therefore less relevant, and are shown somewhat more strongly distorted, as is obvious from the comparison of the upper image edges or the horizons of FIGS. 3a and 3b.

It is directly apparent from FIGS. 2a through 3b that the example rectification according to the present invention, which is directed to the lower image edge (as the relevant image component due to the small distance), displays the traffic situation in particular in the near range more correctly, so that critical situations may be recognized better. The present invention simultaneously may allow the display of the entire surrounding image field, to be able to impart an overall impression, but not at the cost of a distorted and therefore flawed display of the area close to the vehicle (i.e., close to the lower image edge).

One preferred specific embodiment provides displaying further data in addition to the rectified image. Further data are in particular driving parameters, so that in particular the speed may be displayed using a (virtual) speedometer. Such a display may be appended below lower image edge 420 and may thus be combined with the rectified image in a display. As already noted, the display may be implemented with the aid of an electronic display such as an LCD or TFT monitor, heads-up displays also being able to be used.

Finally, it is to be noted that FIGS. 2a through 3b show a camera display in which the camera is not oriented completely level to the horizon. Therefore, horizontal also refers to an approximate orientation to the horizon, i.e., having an angle offset of 5°, 10°, 20°, or more, since an approximate orientation also ensures that lower areas of the display reproduce areas close to the vehicle and therefore the improved reproduction according to the present invention of the areas close to the vehicle is ensured. This is accordingly true for the vertical, the vertical not necessarily exactly forming a 90° angle with the horizontal, but rather an angle of at most 5°, 10°, or 20°. The above-mentioned present invention is described in particular for vehicles in which the near range, which is displayed on the lower image edge, is the critical area. However, the present invention may also be used for other applications, in which, for example, the upper edge area or the lateral edge area is particularly relevant and is rectified according to the present invention. The associated functions, modes of operation, and features result from the preceding statements and a corresponding rotation.

What is claimed is:

1. A method for the visual display of surroundings of a vehicle, comprising:
recording a surrounding image field with the aid of a wide-angle lens;
rectifying the surrounding image field recorded with the aid of the wide-angle lens by producing a display image field which reproduces the surrounding image field in rectified form, the rectification including imaging the surrounding image field according to a rectification acting at least in a vertical direction, which images a lower edge of the recorded surrounding image field on a lower setpoint image edge, which at least approximately corresponds to one of an outer contour section of the vehicle, or a predefined course whose course differs from that of the lower edge, and the rectification represents a unique image at least for a subgroup of pixels of the surrounding image field which are not on the lower edge; and
displaying the display image field.

2. The method as recited in claim 1, wherein the rectification runs only in the vertical direction and a strength of the rectification in the vertical direction corresponds to a vertical difference between a setpoint image edge and the lower edge.

3. The method as recited in claim 1, wherein the recording step includes recording the surrounding image field with the aid of an electronic camera through the wide-angle lens, and the camera converts the surrounding image field into camera image data, wherein the imaging step including imaging by an electronic image processing device, which rectifies the camera image data according to the rectification, and the image processing device including one of a rectification function dependent on a horizontal position specification, the rectification function reproducing a vertical distance between the lower edge of the surrounding image field and a lower setpoint image edge dependent on the horizontal position specification, or an actual function dependent on a horizontal position specification and a setpoint function dependent on a horizontal position specification, the actual function reproducing the vertical height of the lower edge of the surrounding image field as a function of the horizontal position specification and the setpoint function reproducing the vertical height of the setpoint image edge as a function of the horizontal position specification, and the imaging being performed by a vertical offset of the camera image data according to one of the rectification function or a difference between the actual function and the setpoint function.

4. The method as recited in claim 1, wherein the rectification provides that all pixels of the surrounding image field which are in a same vertical are vertically displaced by a same amount.

5. The method as recited in claim 1, further comprising:
interpolating the surrounding image field mapped according to the rectification or interpolating image field data during the imaging, wherein the interpolating includes: interpolating color or grayscale values which reproduce the surrounding image field according to at least one of a linear interpolation, a bilinear interpolation, a higher-order interpolation, a cubic interpolation, a bicubic interpolation, and an interpolation running in the vertical direction and in a direction horizontal thereto.

6. The method as recited in claim 1, wherein the lower edge of the recorded surrounding image field has a curved course, which is provided with the aid of one of a polynomial function, a polynomial function symmetrical to a vertical, a polynomial function having a minimum in the center or between lateral edges of the surrounding image field, a circular arc function, or another function which reproduces a curvature of an image edge arising due to a wide-angle lens, and a course of the outer contour section corresponds to at least one of a real course of a contour of the vehicle, a side of the vehicle, a bumper of the vehicle, or a trunk lid of the vehicle, a course of a rear section of the vehicle, or a predefined course, a symbolic course, a horizontal course, a straight line, or a horizontal straight line.

7. The method as recited in claim 1, wherein the display field is displayed using a visual display, which has generally no distortion, and the visual display is situated in a passenger compartment of the vehicle and faces toward a driver position in order to display the display image field to the driver, the visual display in being one of an LCD or TFT display screen.

8. The method as recited in claim 1, wherein the display image field is larger than the rectified surrounding image field, and at least one of graphic, symbolic, numeric, and alphanumeric vehicle information is reproduced in a remaining area of the display image field, the vehicle information reproducing vehicle parameters including at least one of speed, a distance between the vehicle and an object in the surroundings, a movement direction of the vehicle, a steering direction of the vehicle, and a symbolic representation of detected traffic surroundings of the vehicle.

9. A device for visual display of surroundings of a vehicle, comprising:
a camera which has a wide-angle lens;
a graphic data interface for outputting display image data which reproduce a display image field; and
an imaging device which is connected to the camera to receive surrounding image data, which reproduce a surrounding image field, and which is configured to display image data of the surrounding image field according to at least one rectification acting in a vertical direction and supply the rectified image data to the graphic data interface, wherein the rectification is provided to show a lower edge of the recorded surrounding image field on a lower setpoint image edge, which at least approximately corresponds to one of an outer contour section of the vehicle, or a predefined course whose course differs from the lower edge, the imaging device being configured to provide the rectification, which is provided by the imaging device, as a continuous image for pixels of the surrounding image field which are not on the lower edge.

10. The device as recited in claim 9, further comprising:
an interpolation device, which is one of part of the imaging device or connected downstream from the imaging device, wherein the interpolation device is configured to interpolate color or grayscale values which reproduce the surrounding image field, and to smooth a transition between different displacements in the vertical direction, which are provided by the imaging device, through the interpolation.
